(19) United States
(12) Patent Application Publication
(10) Pub. No.: US 2011/0313803 A1
(43) Pub. Date: Dec. 22, 2011

(54) Social Task Lists

(75) Inventors: Ned B. Friend, Seattle, WA (US); Michael Ivan Borysenko, Redmond, WA (US); Owen Braun, Seattle, WA (US); Gregory J. Hollobaugh, Seattle, WA (US); Erez Kikin-Gil, Redmond, WA (US); Matthew J. Kotler, Sammamish, WA (US); Charles W. Parker, Sammamish, WA (US); Tara Leigh Roth, Bellevue, WA (US); Jesse Clay Satterfield, Seattle, WA (US); Nathaniel Stott, Redmond, WA (US); Igor Zaika, Seattle, WA (US)

(73) Assignee: Microsoft Corporation, Redmond, WA (US)

(21) Appl. No.: 12/820,721

(22) Filed: Jun. 22, 2010

(51) Int. Cl. G06Q 10/00

(52) U.S. Cl. 705/7.13

(57) ABSTRACT

Providing access to task lists via social communications systems is provided. A user may expose a list authoring surface and associated task lists to other users via one or more social communications systems. When another user attempts to access contents of the list authoring surface, the user attempting access may be required to provide permissions credentials, or the attempting user's social communications account may be designated as a permissioned account from which access to the contents of the list authoring surface may be obtained. Version control management may be applied to the accessed task lists to ensure accessing users receive access to most up-to-date versions of accessed task lists. Once an accessing user obtains access to a given task list, the accessing user may comment on accessed tasks, make changes to accessed tasks and/or collaborate on accessed tasks.

### BACKGROUND

With the advent of computers and computer software, a number of advancements have been made to help people manage both their working and non-working lives. To help people who are trying to juggle numerous tasks at work, at home, and in between, electronic tasks and calendaring programs have been developed to assist with the often daunting task of maintaining, tracking and remembering all the things that must be accomplished on a daily basis. Because many people work in groups, with family members or on teams, and because of the rise in use of social networks, many people wish to collaborate on task management and task completion through social communications. However, sharing tasks electronically is difficult. In order to do so, users typically have to copy tasks into an electronic mail or other communication medium and send the tasks to other users for sharing purposes. In addition, providing access to task lists via social communications can present security problems as to who is allowed access to task lists or related information of a given user. In addition, if multiple persons are allowed access to given task lists, another problem may arise as tasks are modified or completed because various persons accessing the tasks may not be accessing most up-to-date versions of task lists at any given time. And, persons responsible for different tasks may not be aware of the changes made to one or more task items by others. With multiple persons accessing, modifying or completing tasks on a given task list, tracking activities of persons with access to the task list may be necessary to maintain the task list in an up-to-date manner.

It is with respect to these and other considerations that the present invention has been made.

### SUMMARY

Embodiments of the present invention solve the above and other problems by providing access to task lists in social contexts, for example, through electronic mail, text messaging, social networking systems, etc. A user may expose a list authoring surface and associated task lists to other users via one or more social communications. When another user attempts to access contents of the list authoring surface, the user attempting access may be required to provide permissions credentials, or the attempting user's social communications account may be designated as a permissioned account from which access to the contents of the list authoring surface may be obtained. Version control management may be applied to the accessed task lists to ensure accessing users receive access to most up-to-date versions of accessed task lists and that accessing users may see changes that have been made to task list items. In addition, once an accessing user obtains access to a given task list, the accessing user may comment on accessed tasks, make changes to accessed tasks and/or collaborate on accessed tasks. Activities of participants in the social network may be monitored, and changes to one or more accessible task lists may be made as necessary.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

FIG. 1 is a simplified block diagram illustrating a list authoring surface user interface deployed on a display screen of a computer monitor.

FIG. 2 is a simplified block diagram illustrating a list authoring surface user interface populated with one or more tasks, events, activities, or pieces of information deployed on a display screen of a computer monitor.

FIG. 3 is a simplified block diagram of the list authoring surface user interface of FIG. 2 showing a list of information pivoting out from a selected task item.

FIG. 4 is a simplified block diagram of a computing architecture in which embodiments of the present invention may be practiced.

FIG. 5 is a simplified block diagram illustrating a list authoring surface user interface displayed in association with a displayed document.

FIG. 6 is a simplified block diagram illustrating a mobile computing device and illustrating a list authoring surface user interface deployed on a display screen of the mobile computing device.

FIG. 7 is a simplified block diagram illustrating a mobile computing device and illustrating a list authoring surface user interface deployed on a display screen of the mobile computing device.

FIG. 8 illustrates an example user interface component for providing versioning control in association with task lists or individual task list items.

FIG. 9 is a flowchart illustrating a method for managing access to a user's task lists via social communications and media sites or other communication media.

FIG. 10 is a simplified block diagram of a computing system in which embodiments of the invention may be practiced.

### DETAILED DESCRIPTION

The following detailed description refers to the accompanying drawings. Wherever possible, the same reference numbers are used in the drawing and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims.

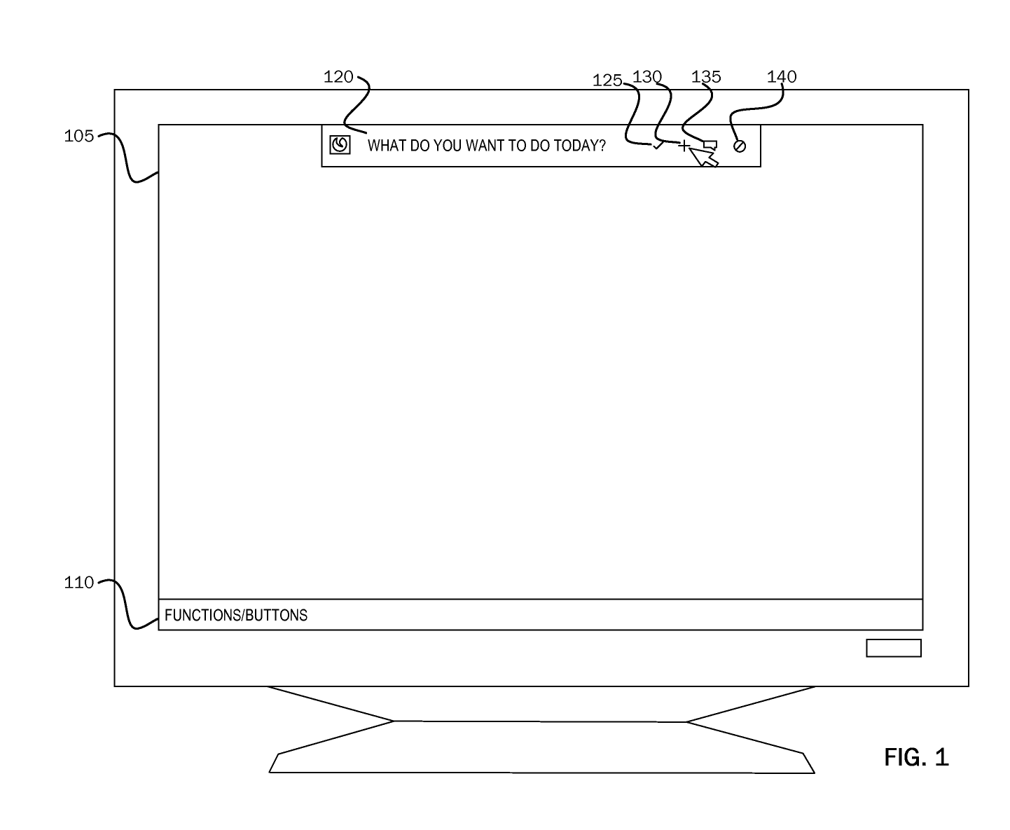

As briefly described above, embodiments of the present invention are directed to providing access to and managing task lists via social communications systems. FIG. 1 is a simplified block diagram illustrating the list authoring surface user interface deployed on a display screen of a computer monitor. The list authoring surface includes a lightweight user interface 120 (also referred to herein as a list user interface) that may be deployed across a number of software applications and that may be displayed on stationary and/or mobile computing device desktops or display areas. For example, as illustrated in FIG. 1, the list authoring surface user interface (LASUI) is shown deployed on a display screen 105 of a stationary computer monitor. As should be appreciated, the display screen 105 may be illustrative of a display space associated with a computer operating system, or a display space associated with one or more software applications, for example, word processing applications, spreadsheet applications, slide presentation applications, notes applications, calendaring applications, contacts applications, and the like. A row of functions/buttons 110 is illustrated at the bottom edge of the display screen 105 for providing access to one or more functionalities associated with an example software application or operating system. As should be appreciated, the configuration and location of user interface components illustrated in FIG. 1 are for purposes of example only and are not limiting of other configurations that may be possible. That is, the LASUI 120 may be deployed along an upper edge of the display screen 105, as illustrated in FIG. 1, or the LASUI 120 may be deployed at other locations in the display screen as required by a user for effective utilization of the display screen.

According to embodiments, the list user interface 120 of the list authoring surface may be utilized as an electronic note, scrap of paper, note pad, “sticky” note, and the like that is associated with one or more software application displays for entering either manually or automatically list items, such as tasks, events, activities or other pieces of information, that a user might otherwise jot down on a piece of paper, note or other media for keeping in the forefront such information considered important to the user or for reminding the user. In addition to entering information into the user interface 120, the user interface 120 may be used for quick capture of information from opened documents and in association with opened applications so that the user does not have to leave a current application to launch a task entry user interface. Indeed, the list authoring surface UI 120 may be associated with a variety of electronic files, such as electronic documents, electronic mail items, contacts items, social networking information, and the like.

As illustrated in FIG. 1, one or more functionality buttons or controls 125, 130, 135, 140 may be provided in the list authoring surface UI 120 for editing or otherwise manipulating information contained in the UI 120. For example, a control 125 may be utilized for “checking off” completed tasks, a control 130 may be utilized for adding additional tasks, events or other information, a control 135 may be utilized for importing information or for annotating information to be stored or displayed in the user interface 120, and a variety of other controls 140 may be provided for other types of editing, sorting, filtering, searching, and the like information contained in the user interface 120.

According to an embodiment, one such control may be used to set the computer with which the list authoring surface is utilized to a “do not disturb” mode so no new email items, instant messaging (IM) items, or other distractions would come to the list authoring surface when the “do not disturb” mode is activated. Another such control 140 may allow a “snooze” mode to be applied to the task currently displayed so that a new task could be displayed instead and so that a user would not have to decide what to do with respect to the “snooze” task. That is, the user could hold the task by applying the “snooze” mode. In addition, the “snooze” mode may be used to filter out information not relevant to the current task only. For example, if a user applies the “snooze” mode to a task of “Plan morale event,” and if the user's current task is “Redesign product,” and the user gets an email from his/her supervisor about this project, the email about the task of “Redesign project” may be displayed, but emails about the “Plan morale event” task may not be displayed to the user.

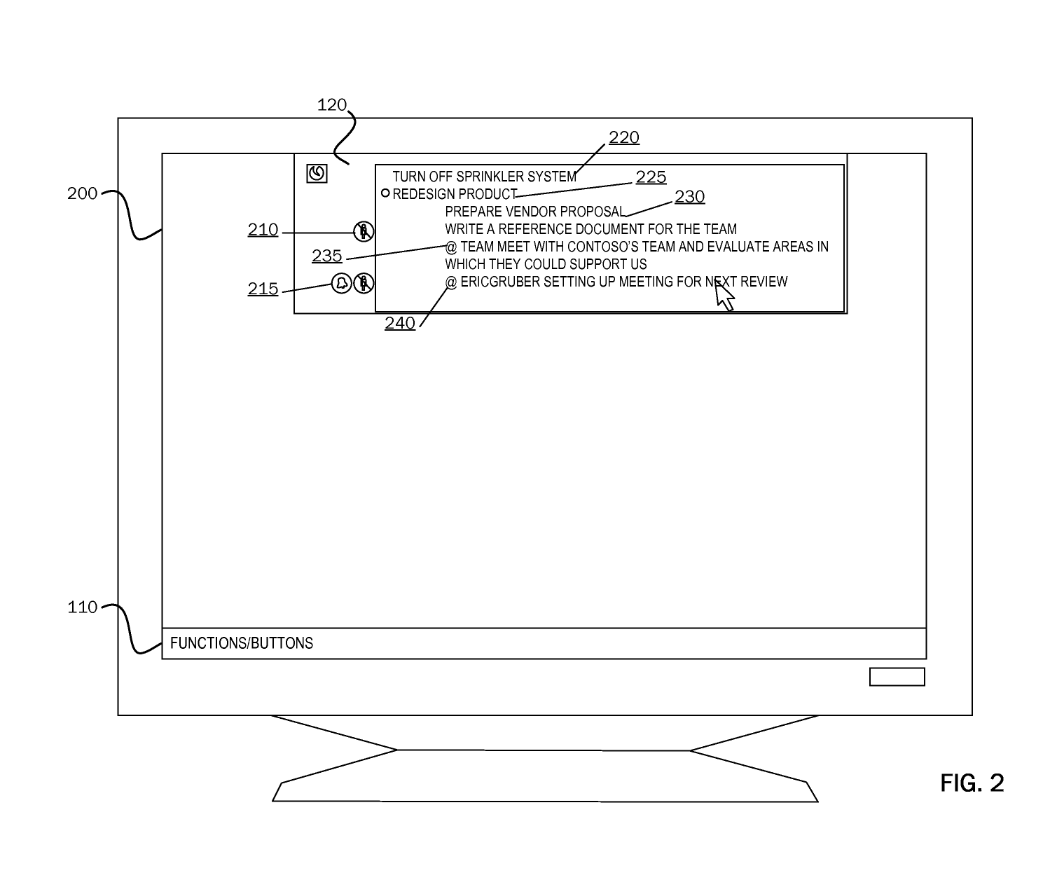

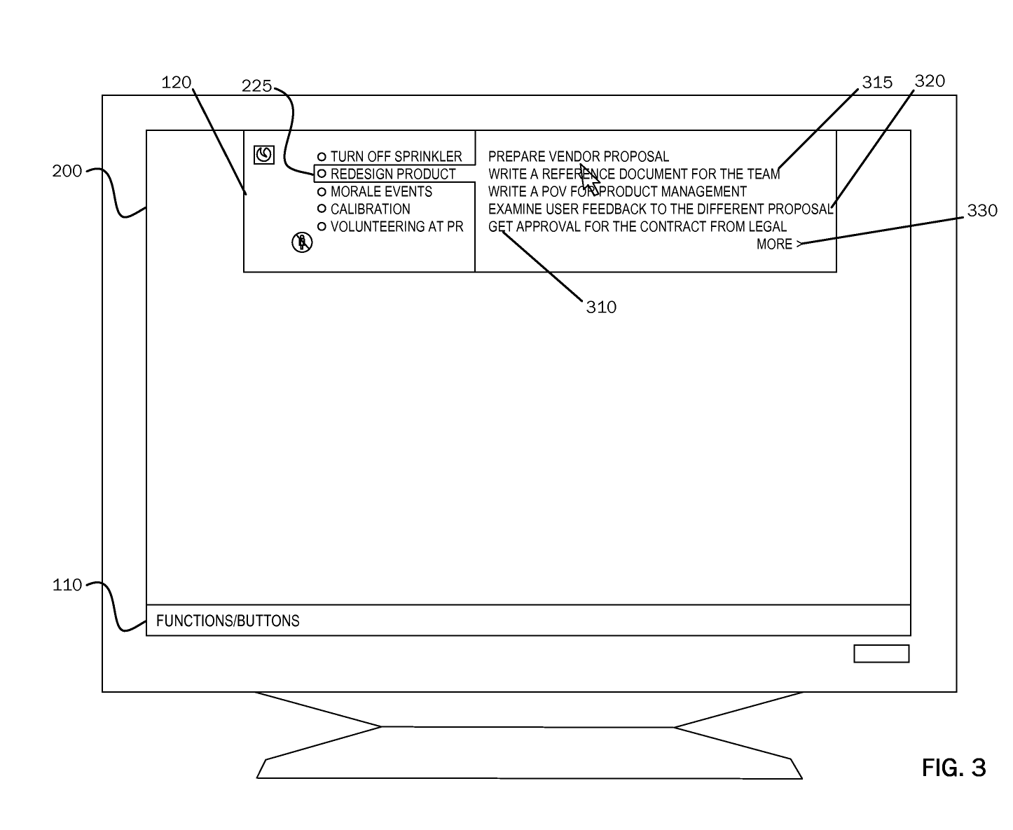

Referring now to FIG. 2, the list authoring surface user interface 120 is illustrated in an expanded form showing a variety of list items, for example, tasks, events, activities or other pieces of information, that have been entered either manually or automatically through information capture into the list authoring surface. For example, a first entry 220 of “Turn off sprinkler system” is illustrative of a task a user may enter into the list authoring surface user interface 120 to remind the user to handle this task when he returns home. For another example, a second entry 225 of “Redesign product” is illustrated having a number of subtasks 230 associated with the main task 225. Items displayed in the LAS UI 120 may be displayed according to one or more specified display arrangements, for example, based on designated time of performance, most recent on top, top 5 items as designated by a user, and the like. Such display arrangements may also apply to pivoted displays as described below with reference to FIG. 3.

Advantageously, entering and editing information into the list authoring surface UI 120 is easy and efficient. For example, information may be typed into the UI in a similar manner as entering a bulleted list of items in a word processing document. That is, the user may enter an item, select the “enter” key, “tab” key, or the like, and subsequent entries will be placed in the next row or sentence in the UI 120, but still have all of the benefits of any applied metadata. For example, the LAS UI may be formatted such that a simple carriage return or tab selection may create a hierarchy in entered list items that may be beneficial to the user. For example, the user may enter a first task of “Plan dinner party,” followed by a carriage return or tab and then the entry of “Reserve restaurant,” followed by another carriage return and the entry “Review menu offerings.” By applying a hierarchical formatting to the entered items, the second two items may automatically be listed beneath and indented relative to the first item to create a displayed hierarchical relationship between the items.

According to embodiments, once data or other information is populated into the list authoring surface UI 120, metadata, for example, the phrase “@Team” may be entered into the LAS UI 120 as one or more text entries and may be applied to key words, key terms, key phrases, or other information components of a task list item to allow for structuring, editing, filtering, searching, sorting, or other automated manipulation of task list items (i.e., tasks, text or information) contained in the UI 120. Alternatively, metadata items may be selected from a menu of metadata items for application. For example, the metadata “@Team” may be applied to the task “Meet with Contoso's team and evaluate areas in which they could support us” to indicate that the example task is one of one or more tasks to be completed by a given team. In contrast, the metadata “@EricGruber” is applied to a task of “Setting up meeting for next review” to indicate that task is associated with a particular person.

Many other types of metadata may be applied to information in the list authoring surface UI 120. For example, while the example “@” symbol is used above to associate a task with a person or group, the “#” symbol may be used for tagging a task or other information with random metadata. For other examples, the “$” could be used to tag monetary information, the “&” symbol could be used to tag dates or time. As should be appreciated, any of a great number of such metadata types and symbols could be used, and the foregoing are for purposes of example only. Advantageously, such metadata items may be associated with information in the list authoring surface UI without entering another text or data entry field or without launching any other user interface component. As also should be appreciated, such metadata applied to various information in the list authoring surface UI 120 will allow for sorting, searching, filtering or otherwise manipulating the information contained in the UI 120. For example, using the metadata “@Team” may allow a sorting on all tasks, events, or other pieces of information to be performed by or that are associated with the team of personnel associated with the metadata “@Team.”

In addition to using applied metadata to allow manipulation of information in the list authoring surface UI 120, applied metadata may also be used to add or manipulate data in other list authoring surface Uls of other users. For example, if a first user enters or captures a given piece of information in her list authoring surface UI, and then applies a metadata item such as “@Sarah” to the information, according to an embodiment, “Sarah” may now have the tagged information automatically populated into her list authoring surface UI so that she sees the tagged information as well.

As should be appreciated, an almost limitless amount and type of metadata may be applied to various pieces of information entered in the list authoring surface. For example, such metadata terms as date, time, location, name, address, telephone number, alphanumeric, audio, video and the like may be applied to one or more words, phrases, data, files, and the like for allowing future editing, sorting, searching, or manipulation of the information contained in the list authoring surface. For example, if a metadata type of “date” is applied to all dates contained in the list authoring surface UI 120, such metadata may be utilized for tagging dates contained in the UI 120 to allow a user to filter, sort, or search data contained in the UI 120 based on date. For example, a user may desire to sort all information contained in the UI 120 by date to allow the user to quickly see those tasks or events that are occurring or that should be performed today.

In addition to the application of metadata to one or more words, phrases or other pieces of information, natural language processing may be utilized for tagging and/or applying metadata to information contained in the list authoring surface. For example, if a phrase such as “Meet at Bob's Pizza Parlor at 6:00 p.m. on Friday” is entered into the list authoring surface user interface 120 a natural language processor may be applied to the phrase to parse the words to determine whether any of the words are associated with a particular information or data type. For example, each word or combination of the words in the example task item may be parsed to determine whether any particular information type is involved. For example, the words “Bob's Pizza Parlor” may be tagged as a name of a business, the time “6:00 p.m.” may be tagged as a time, and the day “Friday” may be tagged as a particular day. A natural language processor may parse such phrases into one or more words, and the one or more words may be used for searching dictionaries or stores of words for matching the parsed words with various known words such as restaurant names, times, days, and the like. Once the natural language processor identifies certain words or phrases as belonging to information types, those words or phrases may be tagged with metadata so that the words or phrases may be utilized for searching, sorting, filtering editing or otherwise manipulating the information, as described above.

In addition to such manipulation of listed information, allowing for acting on the listed information is equally important. For example, functionality buttons and controls may be exposed in the list authoring surface UI to allow actions on listed items. For example, the listing of a contact item, such as “Bob's Pizza Parlor” may cause the listing of a “call” button which when selected causes a telephone program to call the listed contact, or an “email,” “text” or similar button which when selected may allow an email or text message to be sent to the contact, etc. As should be appreciated, many other types of action controls may be exposed for listed items. For example, a control for adding listed names and related information to a contacts folder may be exposed, and the like.

In addition to natural language processing, other methods for recognizing and utilizing particular pieces of information may be used. For example, other methods may include, parsing text or data and passing the parsed text or data to one or more recognizer modules. Still other methods may include use of data analytics to analyze all of the data on the server and show auto-complete or other information (e.g., everyone who enters “Christmas” also happens to tag it with “#holiday” and perhaps you the user would like to as well). In addition, search may be used, for example, entering “Bob's Pizza Parlor” would cause a detection/identification by doing a search and seeing that “Bob's Pizza Parlor” is actually a restaurant that has an associated URL such as www.bobspizzaparlor.com.

According to embodiments, in addition to metadata tags, other list item attributes, including other forms of metadata, may be applied to list items entered into the list authoring surface. For example, list item attributes, such as team attribute, person attribute, date attribute, time attribute, location attribute, name attribute, address attribute, telephone number attribute, alphanumeric attribute, audio attribute, video attribute, and the like may be applied to a given list item. As should be appreciated, the list item attributes may be extensible and customizable, for example, price attributes, location in a store of items on a purchase list, etc. For example, a list item of “@Team1Meet at 2:00 pm to discuss project” may be additionally annotated with a list item attribute of a person's name, such as “Joe,” to create a modified list item of “@Team1Meet at Joe's office at 2:00 pm to discuss project.” The list authoring surface may then associate the first metadata item of “@Team” with the list item attributes of “2:00 pm” and/or “Joe's office” to generate a task for display in the list user interface 120 of all users who are members of “@Team1.”. Association of such metadata items and list item attributes may allow the task to be used more effectively. For example, the resulting task item, may allow the list authoring surface to retrieve information about the members of “Team1,” for example, calendaring information to determine whether the members are available at “2:00 pm,” and/or the list authoring surface may retrieve contact information to determine the location of “Joe's office.” Such information may be automatically added to the list authoring surface 120 as a pivot item out from the resulting task. As should be appreciated, these are only examples of the many ways in which metadata items and other list item attributes may be associated to enhance the effectiveness of task items in the list authoring surface.

Information entered into the list authoring surface UI 120 and tagged or grouped according to one or more metadata types, list item attributes or in association with a natural language processor, as described above, may then be utilized in a variety of helpful ways, including generation and display of resulting tasks. For example, date and/or time annotation or tagging applied to tasks, events, activities or other pieces of information (hereafter referred to as “tasks”) may be utilized for manipulating, e.g., editing, sorting, searching, or otherwise manipulating, tasks and related information contained in the list authoring surface according to any applied metadata or list item attributes, e.g., date/time, people, teams, etc. In addition, tasks annotated with a date and/or time metadata may be organized in an events timeline and may be further annotated to help the user accomplish or otherwise handle tasks along a prescribed timeline. As referred to herein, timeline may be broadly defined to include any time representation, including dates, times, calendar information, seasons, years, etc. For example, certain tasks may have hard deadlines, for example, a doctor's appointment on a specific date and time that may not be moved by the user.

Other tasks may require accomplishment or handling during a prescribed date/time range, for example, some time on Friday before 6:00 p.m. According to embodiments of the invention, such date and/or timing information may be applied to tasks entered into the list authoring surface user interface 120 to apply a “fuzziness” to the timing aspect of tasks contained in the user interface. For example, if on a given day two tasks must be accomplished or otherwise handled at very specific times, then those tasks may be annotated with metadata allowing the user to sort, search or otherwise manipulate those items based on the hard dates/times applied. On the other hand, if one or more other tasks must be completed on the same day, but may be completed at any time up to a given end time, for example, 6:00 p.m., then those tasks may be annotated with a metadata type allowing those items to move in the events timeline associated with tasks that must be accomplished or otherwise handled on the prescribed day so long as the times for accomplishing or otherwise handling those items do not go beyond a prescribed outer time limit, for example, 6:00 p.m. For another example, if a user wants to mow his/her lawn in the morning and go to a specific restaurant that evening, the list authoring surface may allow capturing times like “Morning” and “Evening” in the same way that using a paper calendar they may put the mowing activity towards the top of the box for that day and the restaurant name towards the bottom of the box for that day without a specific time for either. According to an embodiment, then, sorting, searching or otherwise manipulating list items contained in the list authoring surface UI 120 may be accomplished on list items having hard date/times, or may be accomplished on list items having soft or fuzzy date/times, or a combination thereof.

The list authoring surface UI 120 may provide reminders to the user to accomplish or otherwise handle tasks contained in the list authoring surface UI 120, and the inclusion of metadata associated with hard dates/times and metadata associated with soft or fuzzy dates/times may be utilized for providing a more realistic experience to the user. For example, a reminder of an upcoming hard date/time, for example, a specific appointment, may be of one variety of reminder and a reminder associated with a soft or fuzzy date/time may be of a different type of reminder that is less urgent in comparison to a reminder associated with a hard date/time. In addition, tasks associated with a soft or fuzzy date/time may be automatically floated through a given day's schedule until a prescribed end point, for example, no later than 6:00 p.m. is approached. Thus, the reminders associated with hard date/time items as compared to soft or fuzzy date/time items may be accomplished in a way that more closely approximates how a user might remind himself or herself of such items by jotting the items down on a scrap of paper, notepad, sticky note, and the like.

As described in further detail below, the list authoring surface user interface 120 may be deployed in association with a multitude of software applications and data associated with different software application types. For example, the list authoring surface may be utilized for receiving information from or capturing information from a variety of electronic files, such as word processing documents, spreadsheet application documents, slide presentation application slides, Internet browser content, social media site content, video applications, audio applications, electronic inking, for example, handwriting electronically with a stylus and electronic writing pad, photographs, electronic mail items, calendar items, task items from other tasks, speech-to-text files, and the like. In addition, information stored for the list authoring surface may be utilized by other applications for enhancing the functionality of the list authoring surface.

Consider the example entered or captured task in the form of the phrase “Meet at Bob's Pizza Parlor at 6:00 p.m. on Friday.” Once individual words or phrases in the entry are parsed, recognized, annotated, or otherwise tagged with metadata as described above, those tagged items may be utilized by other applications to enhance the functionality of the list authoring surface. For example, the business name of “Bob's Pizza Parlor” may be passed to a software application for determining a location of Bob's Pizza Parlor. The location of Bob's Pizza Parlor may in turn be passed to a global positioning system (GPS) mechanism of the user's global device, for example, a phone, personal digital assistant, etc., the time associated with the entry of “6:00 p.m. on Friday” may be passed to a calendar function utilized by the user, and any other words or phrases of interest in the phrase may be thus utilized. Now, following with this example, if the user leaves his or her office and is utilizing a mobile device, to which he has deployed the list authoring surface UI 120, as will be described below, as the user approaches the location of the example “Bob's Pizza Parlor” or as the user approaches the designated time of “6:00 p.m. on Friday,” or a combination of the two, a reminder may be provided to the user via his mobile device that the time for meeting at “Bob's Pizza Parlor” is approaching, or that the location of “Bob's Pizza Parlor” is approaching, or of a combination of the above. Use of presence data (for example, location of a mobile device as determined by signal strength or GPS positioning) may also be used to relate information or task reminders in the list authoring surface to other pertinent information, such as calendar items, meeting locations, etc. In addition, if the meeting reminder is associated with a particular person or group of persons, the list authoring surface may query a contacts application for contacts information for the person or persons and make that information available through the list authoring surface UI 120.

For another example, if a user enters a task associated with the editing of a particular portion of a given word processing document, metadata associated with an identification of the particular document may be applied to the task entered into the list authoring surface user interface 120. When the user next opens the specified word processing document, a reminder may surface in the list authoring surface UI 120 to remind the user that a particular paragraph in the word processing document should be edited. According to one embodiment, if such a document is not already opened, if the user sees a reminder to edit an identified document, the document may be opened directly from the list authoring surface UI 120 by selecting the document identified in the UI 120.

Referring still to FIG. 2, one or more functionality buttons and controls may be exposed in the user interface 120, in addition to those described above with reference to FIG. 1. A reminder function 210 may allow a user to mark a given task or information item in the UI 120 for setting a desired reminder date/time. A private notification function 215 may allow a user to mark a given task or information item as “private” so that the task or information item is not exposed to other users via their list authoring surface user interfaces. As should be appreciated, the functions 210 and 215 are only examples of the many functions that may be exposed in the list authoring surface UI 120 for applying useful metadata or function to tasks or information items listed in the UI 120.

FIG. 3 is a simplified block diagram of the list authoring surface list user interface of FIG. 2 showing a list of information pivoting out from a selected task item. As should be appreciated, for any individual task or other piece of information entered into the list authoring surface, one or more subtasks, sub events, or sub items of information may be entered and associated with any previously entered tasks. For example, referring to FIG. 3 a variety of tasks or other pieces of information 315, 320, have been entered in association with a parent task 225 of “Redesign product.” According to an embodiment, selection of the parent task 225 allows for the launching of a pivot table 310 within the list authoring surface user interface 120 for displaying the subtasks 315, 320 associated with the parent task 225. A “More” button 330 is illustrated for allowing a display of additional subtasks 315, 320 under the selected parent subtask 225 if the available size of the user interface 120 only provides for an initial display of a fixed number of tasks, events, activities or other pieces of information. According to one embodiment, a specified maximum number of displayed subtasks, for example five subtasks, may be displayed to keep the user's focus on a “top” number of important tasks. As should be appreciated, subtask information displayed in the pivot table 310 may be filtered, searched, sorted, or otherwise manipulated as is the case with information contained in the main user interface 120.

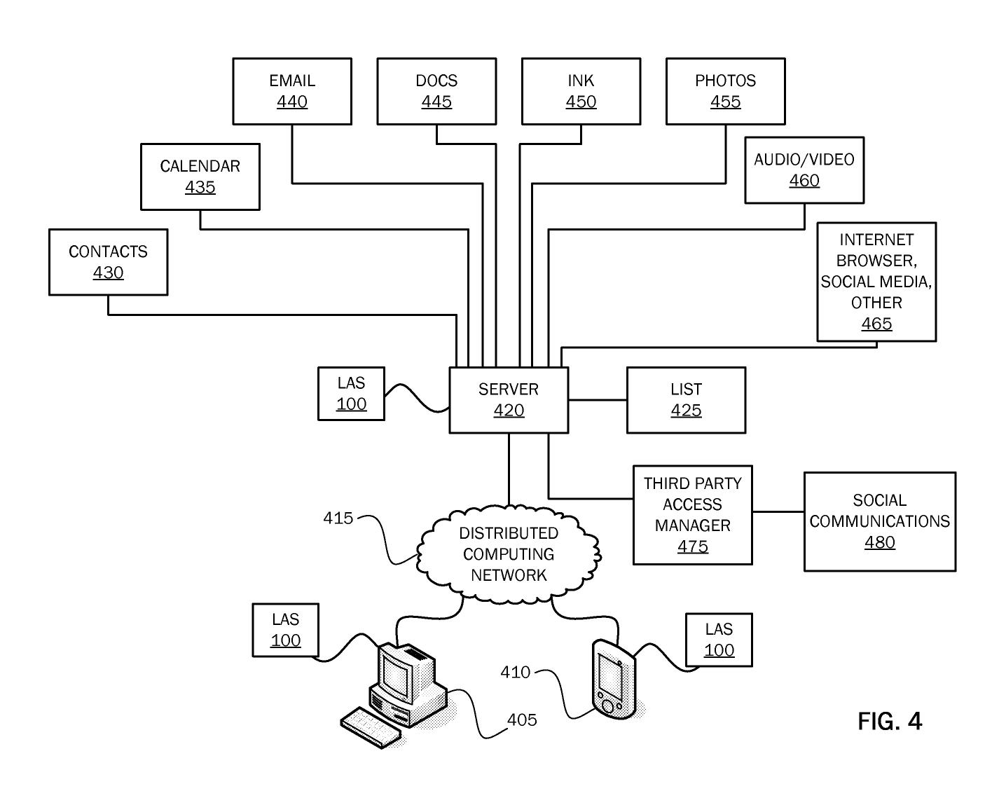

FIG. 4 is a simplified block diagram of a computing architecture in which embodiments of the present invention may be practiced. Referring to FIG. 4, the desktop or laptop computer 405 is illustrative of any stationary computing device utilized by a user for entering, capturing or otherwise utilizing data in association with the list authoring surface described herein. The mobile device for 410 is illustrative of a mobile telephone, personal digital assistant, wirelessly connected laptop computer or any other computing device with which a user may utilize the list authoring surface in a mobile environment. The distributed computing network 415 is illustrative of any suitable means for allowing the computing devices 405, 410 to communicate with one or more applications or databases via a remote server 420, for example, the Internet, a corporate intranet, a home-based intranet, and the like.

The server 420 is illustrative of a general purpose computing device operating as a remote server on which the functionality of the list authoring surface may be maintained for allowing the list authoring surface to follow the user from one device 405 to another device 405 to a mobile device 410, or to any other device on which the list authoring surface UI 120 may be deployed for use as described herein. According to an embodiment, all functionality and data storage associated with the list authoring surface and the associated user interface 120 may take the form of a list authoring surface application or module 100 having sufficient computer-executable instructions for performing the functions described herein. The list authoring surface application or module 100 may be resident on a single computing device 405 or 410 for use in association with data accessible by the devices 405 and 410. Alternatively, the functionality and associated data for the list authoring surface and its associated user interface 120 may be maintained and operated at the remote server 420, as illustrated in FIG. 4.

The list 425 is illustrative of a database list or table accessible by the device 405 or 410 locally or via the server 420 where information entered manually or automatically into the list authoring surface and displayed via the associated user interface 420 is maintained. As should be appreciated, if the user is not in a distributed computing environment, the list 425 and associated stored data may be stored or cached on a local computing device 405, 410. That is, according to an embodiment, each instantiation of the list authoring surface may cause the generation of a list table 425 maintained in a database stored locally on the computing device 405, 410 or stored in association with the server 420.

In the list 425, each task, event, activity, or other piece of information may be assigned to and stored in a given line in the list 425. In addition to storing each individual entry, information identifying annotations applied to individual entries, for example, metadata, or other identifying information may be stored in the list 425 with the associated information entry. Moreover, if the information is associated with other data, for example, a document, calendar item, electronic mail entry, or if an entry is associated with other information, for example, global positioning system location data, date/time data, and the like, information identifying such associations may also be stored on a line in the list 425 or linked to a different list 425 with each associated task, event, activity or other piece of information entered manually or automatically into the list authoring surface. As new data is added to the list authoring surface user interface, or as data is changed in the list authoring surface, or as data contained in the list authoring surface is associated with other information, the data stored in list 425 is updated. According to alternative embodiments, the list items 425 and associated data may be stored according to a variety of different means aside from a data base line described above. For example, the list items and associated data may be stored as extensible markup language (XML) representations or similar representations across multiple linked lists, tables and the like that are available to or accessible by the list authoring surface.

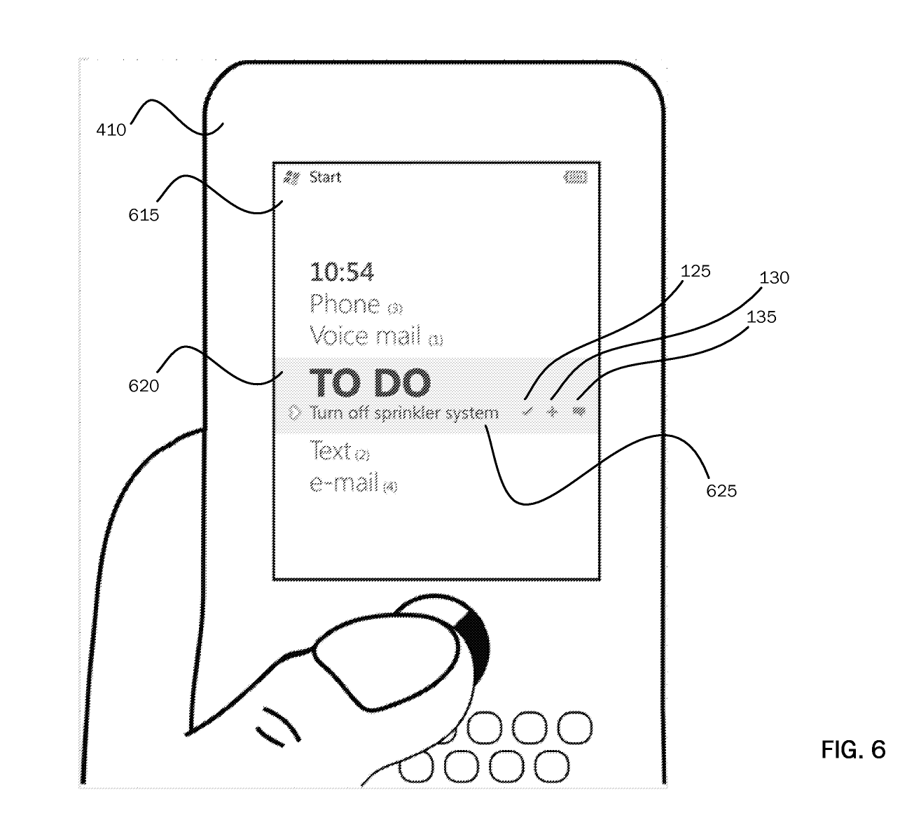

Referring still to FIG. 4, a variety of information sources available to the list authoring surface are illustrated. For example, information from a contacts application or database 430 may be utilized for obtaining information for entry into the list authoring surface. Information from a calendaring application 435 and associated data storage may similarly be obtained. As will be described below with reference to FIG. 6, information from an electronic mail application and associated content 440 may be utilized for populating the list authoring surface. Information from a variety of documents, for example, word processing documents, slide presentation documents, spreadsheet application documents, and the like may be utilized for population of data into the list authoring surface. An ink application 450 is illustrative of an electronic pen and ink application for allowing data entry, for example, through contact of a stylus with an electronic writing pad. Photos applications/storage 455 is illustrative of any application or data storage through which photographs may be obtained and copied or moved to the list authoring surface. The audio/video application and storage 460 is illustrative of one or more means for obtaining audio or video files, for example, a recording mechanism operated through a digital or analog recording device or camera such as might be available through a mobile telephone and the like. Content for the list authoring surface may also come from Internet browsers, social media sites, or other sources 465. As should be appreciated, data and information from any other available source for electronically moving or copying or otherwise entering data may be utilized for populating the list authoring surface and its associated user interface 120 with tasks, events or other information of interest.

While the various data or information illustrated in FIG. 4 are illustrated in association with the server 420, each of these sources of data and/or information may also be directly associated with and/or stored at local computing devices 405, 410. In addition, according to embodiments, information from one or more sources to the list authoring surface is not a one-way communication. That is, according to embodiments, the list authoring surface and/or individual task lists or task list items may be linked to the source from which task list items were obtained (e.g., a word processing document), and information from the task list may be pushed back to the source. For example, if a piece of information in the form of a task item is in the LAS UI 120, that information may be pushed back to a source from which it came. As should be appreciated, a variety of mechanisms may be utilized for pushing information back to the source. A path to the source may be associated with each respective task list item. A selection of the task list item may cause exposure in the LAS UI 120 of a selectable button or control for pushing the selected item back to the source and/or for launching the source document.

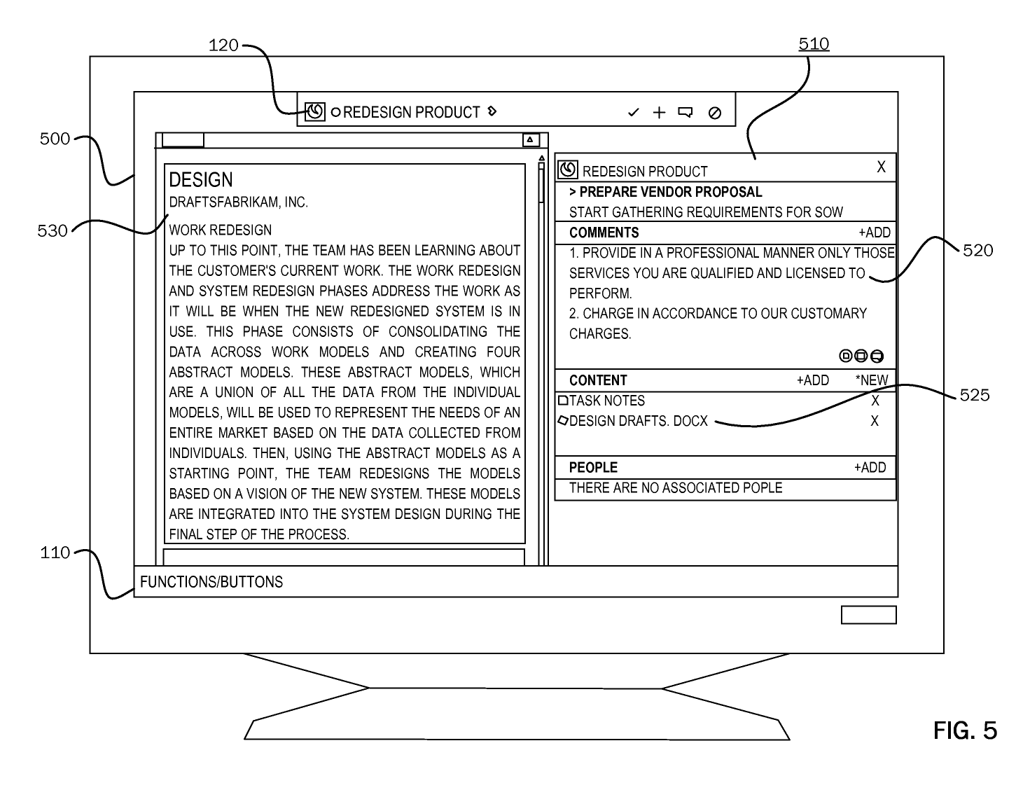

FIG. 5 is a simplified block diagram illustrating a list authoring surface interface and a list authoring surface information input component in association with a displayed document. As described above, information may be entered into the list authoring surface user interface 120 manually or automatically through information capture as described below. As illustrated in FIG. 5, an example document 530 is illustrated displayed on the computer monitor display screen 500 in association with an example word processing application. According to embodiments of the invention, an expanded version of the list authoring service user interface 120 may be deployed as illustrated and described above with respect to FIGS. 2 and 3 for entering any desired information including information about or associated with a displayed document 530. According to another embodiment, a list authoring surface information input component 510 may be deployed in association with the list authoring surface user interface 120 for entering and annotating data about a given task or information item in the list authoring surface UI 120. According to the example illustrated in FIG. 5, the list authoring surface information input component 510 has been launched in association with the task “Redesign product” and displayed in the list authoring surface UI 120. The list authoring surface information input component 510 includes a title section for providing data to identify the information being entered in association with a given task, event or other piece of information included in the list authoring surface. For example, the list authoring surface information input component 510, illustrated in FIG. 5, is identified in association with the task of “Prepare vendor proposal” which is a subtask of the parent task “Redesign product.” Underneath the title portion of the list authoring surface information input component 510 is a comment section 520 for allowing a user to enter comments which may be additional tasks, events, activities or other information associated with the example subtask. For example, the comments entered in the comments section 520 may be subtasks to the subtask “Prepare vendor proposal,” or the comments entered in the comments section 520 may simply be comments to remind the user of various aspects of the associated subtask.

A content section 525 is provided for allowing other content items, for example, documents, audio files, video files, or other content types to be associated with the example task or subtask. A “people” section is illustrated at the bottom of the list authoring surface information input component 510 for associating one or more people, groups of people or teams with the subtask. For example, as was described and illustrated above with respect to FIG. 2, a team grouping that may be utilized in association with a metadata tag of “@Team” may be applied to a given task or subtask. Other groupings or individual persons may similarly be associated with one or more tasks or subtasks entered into the list authoring surface and its associated UI 120. As should be appreciated, the configuration, layout and fields illustrated in the list authoring surface information input component 510 are for purposes of example only and are not limiting of other text, data entry or data annotating fields or sections that may be provided in the list authoring surface information input component 510.

Referring still to FIG. 5, the document 530 displayed on the display screen 500 is illustrative of any document, such as a word processing document, spreadsheet document, slide presentation document, notes document, tasks document, calendaring document, and the like that may be displayed on the display screen 500. As is illustrated in FIG. 5, the document 530 is being processed in some manner by a user, and the user decides to enter information into the list authoring surface via the list authoring surface information input component 510 about the displayed document. For example, as the user is editing the displayed document, the user may remember that one or more tasks should be performed in association with the project referenced in the displayed document. Thus, by launching the list authoring surface user interface 120 and subsequently launching the list authoring surface information input component 510, the user may insert tasks, comments, content items or associate the document or portions of the document or tasks associated with the document with one or more people, groups or teams of people just as the user might handwrite such notes or annotations on a scrap of paper or sticky note to remind the user subsequently to deal with those matters. According to an alternate embodiment, entering tasks or other information into the LAS UI 120 while a document 530 is opened may cause tasks or other information entered into the UI 120 to be automatically associated with the document (i.e., metadata representing the document may be applied to the entered tasks or other information).

As illustrated and described above with reference to FIG. 4, the list authoring surface and its associated user interface 120 may be utilized in a stationary computing system 405, or the list authoring surface may be utilized in association with one or more mobile devices 410. Advantageously, information stored in the list authoring surface in the list 425 in association with the server 420 may be deployed across a variety of applications, as described herein, and may be deployed on a user's mobile device when the user is on the go. Thus, the list authoring surface allows the user to, in effect, carry an electronic version of a “To do” list when the user leaves the desktop operating environment by having the list authoring surface and its associated user interface 120 deployed on his or her mobile computing device, such as a mobile telephone, personal digital assistant, wireless gaming device, and the like.

According to embodiments, the list user interface may be imported to the stationary computing device 405 and to the mobile computing device 410 from the remote server 420. When tasks are displayed in the list user interface, an instantiation of the list user interface may be displayed on the stationary computing device and on the mobile computing device. When changes are made to tasks in the list user interface at the remote server, the changes are passed to the stationary and mobile devices in the form of new instantiations of the list user interface displayed on the stationary computing device and on the mobile computing device. In addition, when changes are made to tasks in the list authoring surface UI 120 at either the stationary or mobile computing devices, such changes may be passed up to the list authoring surface and associated data storage at the remote server 420.

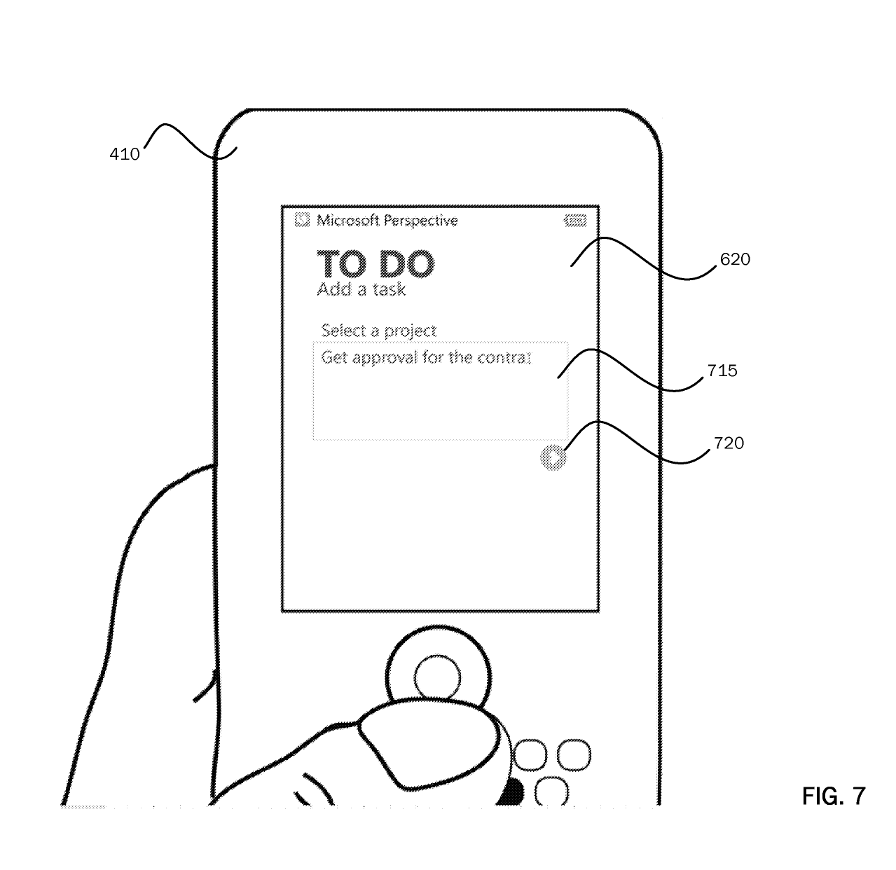

FIGS. 6 and 7 illustrate use of the list authoring surface and its associated user interface in a mobile environment. As illustrated in FIG. 6, the list authoring surface user interface 620 is illustrative of a mobile version of the list authoring surface UI 120, described above, deployed on the display screen 615 of a mobile telephone 610. Just as the user may deploy the list authoring surface user interface 120 on a display screen of his or her computer or laptop, as described above, with reference to FIGS. 1 through 7, so can the user deploy the list authoring surface user interface 620 on his or her mobile device to utilize the same functionality as may be utilized in a stationary computing environment.

Referring to FIG. 7, if the user launches the list authoring surface user interface 620, illustrated in FIG. 6, the “To do” list may be launched on the display screen of the user's mobile device to allow the user to review one or more tasks, events, activities or other information or to allow the user to enter additional information, edit existing information, or otherwise manipulate existing information. If the user does edit or otherwise manipulate information contained in the list authoring surface user interface via his or her mobile device, the modified information may be stored at the list 425 via the server 420, and the next time the user deploys the list authoring surface user interface 120 on his or her stationary computing device, those changes or modifications made to information contained therein via the user's mobile device will appear in the user interface 120 deployed with respect to one or more other applications in the user's stationary computing environment.

In addition, the mobile device 610 may be utilized for quick capture of information that may be exported directly to the list authoring surface, as described below. For example, a camera function of a mobile telephone may be utilized for taking a photograph that may be automatically imported to the list authoring surface. For another example, global positioning system (GPS) data from the mobile device 610 may be captured with respect to a particular location or address and may be imported to the list authoring surface.

As briefly described above, according to another embodiment of the invention, a user may expose the list authoring surface and associated task lists and list items to other users via one or more social communications systems. Social communications systems may include access via electronic mail systems, wireless communications systems, Internet-based access systems, intranet-based access systems, social networking systems such as FACEBOOK and TWITTER, note taking and sharing systems, such as with ONENOTE from MICROSOFT CORPORATION, and the like. In order to grant access by other users to a first user's task lists and associated information, a permissioning system may be utilized to ensure security of the accessed content and to ensure that only authorized persons are able to gain access to the requested content. Once third parties are given access to a first user's task lists and associated content, third party visitors may comment on the user's task list items, including voting up or down the significance or importance of one or more task list items. Visiting parties having appropriate permissioning levels may add new task list items or modify existing task list items.

Once social communications are established between two or more parties, electronic mail or similar communications media may be used for sending task lists from one party to the next along with edits or other modifications to attached task lists. According to one embodiment, no communications between parties is required. That is tasks or other information are generated or modified in the list authoring surface, and all with access to the list authoring surface may view the tasks or other information without communications between various parties. Receiving parties may incorporate received task lists into their own task lists, and changes made to such task lists may be persisted back to memory at a remote server or to local memory on a local computing device. Alternatively, received tasks may be incorporated into a receiving party's own task list automatically if the receiving party has permissions to receive the tasks and any updates. Advantageously, such collaboration on one or more task lists allows for an efficient flow of information, particularly in the case of family and team-working environments. In addition, the use of collaborative lists and the ability to allow third parties to access a task list and to modify, comment on or otherwise interact with a task list allows one member of a team or social network or group to monitor the activities of other members of the group or social network, particularly in the context of team-oriented or group-oriented tasks. In order to ensure that multiple parties are not editing or otherwise modifying a given task or group of tasks simultaneously and thus causing confusion as to the most up-to-date version of one or more tasks, a versioning mechanism may be utilized for notifying users or accessing parties about the version status of a given task item. In addition, of particular importance for the versioning mechanism, is allowing those with access to a given task list to see changes to the task list made since a last review of the task list (i.e., what has been changed, what is new, what has been deleted, etc.).

Referring back to FIG. 4, a third party access manager 475 is illustrated which is a software application module operative to control access by third parties to a given task list 425 in which is maintained task list items for a given task list. As should be appreciated, a given user may have multiple task lists stored in the list 425 and accessible via the server 420, and the third party access manager application 475 may control access to one or more or all of the task lists. According to embodiments, the third party access manager application 475 may operate at the server 420, or may operate on a local computing device 405, 410 for controlling access by any user to the task lists of another user.

Social communications 480 are illustrative of any social communications media, for example, electronic mail communications, wireless communications, Internet-based access systems, intranet-based access systems, social networking systems communications, such as with FACEBOOK and TWITTER, note taking and sharing systems, such as with ONENOTE from MICROSOFT CORPORATION, and the like. That is, the social communications 480 are illustrative of any media or communications method through which one party may contact another party and with which one party may pass information to the other party or to access information owned, operated or controlled by the other party.

As described above, according to embodiments of the present invention, a permissioning system may be employed by the third party access manager for controlling access to one party's task lists by other parties through the social communications 480. According to one embodiment, a requesting user may request access to a first user's task list items through the third part access manager. In turn, the third party access manager may communicate with the first user via the server 420 to notify the first user that the requesting user would like access to the first user's task list items. If the first user approves of the access by the requesting user to the requested task list items, the requesting user will be granted permission to access the requested task list items according to one or more permissioning types. According to one embodiment, a requesting user's social communications account may receive prescribed access permissions, and subsequent access requests received from that social communications account will be treated according to the prescribed permissions.

While the above information from a given task item or task list may be “pulled” by a permissioned user, as described above, sharing of task items and task lists may equally be done via a “push” of those items from one user to another user having permissions to receive or modify or both. For example, the list authoring surface may allow an automatic or case-by-case push of task items or task lists from one user to another via the social communications described herein. For example, a first user creates a shopping list in his/her list authoring surface 100 and associated LAS UI 120, and the shopping list is automatically pushed to another user who has appropriate permissions to receive the list. If the receiving user modifies the list (e.g., adds some additional items), then the versioning control mechanism may ensure the first user knows of the changes to include pushing the changed list back to the first user if so desired.

According to a first permissioning type, the requested task list items will be available to the requesting user to review, comment on, edit, modify, rearrange, or any other change to the accessed task list items, including persisting changes to memory. Under this first permissioning type, the requesting user may have full access to the task list items in the same manner as the first or owning user. According to a second permissioning type, the requesting user may be granted a subset of those access privileges, for example, the user may be allowed to comment on task list items, but the user may not be allowed to modify task list items. According to another permissioning type, the requesting user may be granted full access to some task list items but not to all task list items. For example, some task list items may be designated as private which may be only accessed by the first or owning user, and some task list items may be designated as public to which other requesting users with appropriate permissions may access. Alternatively, various subsets of a first user's task list items may be associated with one or more working teams, and members of the associated working teams may have varying access permissions to the task list items associated with the various teams.

According to another permissioning type, requesting users may receive “read only” access to one or more task list items wherein the requesting users may read the task list items and copy the task list items to a separate task list in the list authoring surface, but wherein the requesting users may not modify task list items in the accessed task list. In addition, other permissioning types may be applied to task list items to allow task list items to be accessed and/or modified based upon context. For example, one or more requesting users may be given various types of access permissions to one or more task lists at certain times of day, or when the requesting users are located at prescribed locations, for example, at work, at home, or when visiting the same facility as the first or owning user.

According to another permissioning type, one or more task list items or task lists may be visible to anyone who may access the items or lists via one or more social communications without any required permissions or credentials. Such a completely open access method may be advantageous in some circumstances where users desire completely open flow of information with respect to task items and task lists.

According to another permissioning type, one or more task list items or task lists may be accessed by third party users based on context. For example, a “home” permission may be applied to a given task list, allowing all members of a home group, such as spouses, kids, etc. to access the list. For another example, a “document” permission may allow third parties associated with a given document to have access to task items associated with the document. For another example, a “work team” permission may give access to all members of a given work team to all task list items associated with the work team. For another example, task list items may be shared with other users based on a “like” or “priority” context. That is, the task list items may be shared with other users performing similar or “like” work functions or working on similar or “like” documents or projects. Or, information may be shared based on sharing priorities. That is, some task lists items may have a sharing priority allowing them to be shared with some users, while other items may have different sharing priorities allowing for more or less access. Thus, an almost limitless number of context-based permissioning types may be utilized as desired by the users of the task list items. As should be appreciated, the various permissioning types described herein are for purposes of example and are not limiting of the various permutations on different permissioning types that may be applied to a given task list or individual task item, as described herein.

As briefly described above, once a requesting user gains access to a first user's task list items, the requesting user may perform various functions with respect to task list items depending on the access permissions granted to the requesting users. According to one embodiment, a requesting user may comment on task list items. For example, if an accessed task list is created and owned by a supervisor of a work team, work team members may gain access to the task list to provide comments on various task list items. For example if a given task list item includes “Prepare proposals for new software development tools,” a requesting user may be a member of a work team and may provide a comment to the example task list items of “We should gather the team to discuss the new development tool because I believe the tool has a number of bugs that need to be resolved.” According to one embodiment, a comment entry user interface component, such as the list authoring surface information input component 510, illustrated in FIG. 5 above.

In addition to commenting on one or more task items, users gaining access to one or more task list items may, in effect, vote up or vote down task list items in terms of their priority in a given task list. For example, a text box may be provided next to each task list item wherein a user may assign a numerical value, for example, on a scale of one to ten, for assigning a desired priority to given task list items. For example, if a given task list has ten tasks that must be performed or accomplished by a family or work group, members of the family or work group may gain access to the task list, as described above, and provide their desired priority to the task list items. According to one embodiment, the first user/owner of the task list may then utilize the list authoring surface to accept or reject the priorities given to the various task list items by members of his/her team. If the first or owner user accepts the priorities given by accessing users, the task list may be reordered accordingly. Alternatively, the first/owning user may simply use the priority information provided by accessing users to inform the first/owning user as to how his/her team believes the tasks should be ordered. As should be appreciated, other mechanisms for allowing accessing users to vote up or vote down the priority or significance of individual tasks may be utilized.

As briefly described above, in addition to accessing a given task list via social communications sites or media, users may collaborate on task lists through other communications means, for example, electronic mail. For example, a sending user may send a task list to other users via electronic mail. Receiving users may receive the task list items, and if desired, may save the received task list items to their own task lists, or may incorporate individual task list items or modifications to task list items to their own task lists. Alternatively, a single task list being used by various members of a given team may be passed around from one team member to the next for review and revision. As desired, any team member with appropriate permissions may save the task list being passed around among members, and the saved task list may be persisted to the list 425 via the server 420 for future access by the various members of the work team or group. According to one embodiment, when changes to task lists are persisted to the list 425 via the server 420, all members of the work team or group may be notified of the changes to the task list.

According to an embodiment, access by various users to one or more task items or task lists need not be via send and receive of those items between the various users. And, there is not particular need for a receiving user to open a task list item or task list via a user interface of a particular social communications system. According to this embodiment, shared task items and task list items may simply be received, reviewed and/or modified via the LAS 100 and associated LAS UI 120. For example, a first user may type a list of items associated with a given project into an email intended for members of a project team. The user may send the email along with the list to the other members of the team and/or the user may capture the list into his/her LAS UI 120 and generate a task or task list from the captured list at the LAS 100. Other members of the team may receive the list via the email, or if they have not reviewed their email, they may see the list pushed to them in their LAS UI 120 without opening the email from the sending user. That is, one of the members of the team with permissions to receive and/or modify the user's task or task list may have the LAS UI 120 launched on his/her computer, and without opening his email, he may receive the list generated by the user pushed to his open LAS UI 120.

In addition to the foregoing, other activities that may be performed by visiting or accessing users, and that may be monitored by a first or owning user or other users of a work team or group include filtering, sorting, or otherwise viewing tasks in one or more accessed task lists, copying task items from other users' task lists, copying calendaring items accessed via other people's task lists, creating task lists from one or more task lists contained in other person's task lists in order to create personalized task lists, and the like. In addition, activity feeds may be established for viewing by various parties through a social communications or media site, for example, FACEBOOK or TWITTER, and changes or modifications, for example, edits or rearrangements of task list items via filtering, sorting, and the like performed on a given task list may be added to an activity feed to allow accessing members to note and review changes to a given task list as they are made. According to an embodiment, the activity feed may be part of an given social network, as described above, or alternatively, the activity feed may be facilitated by the LAS 100 independent of any social networking system such that modifications to task items in a task list to which various users have access are made known to the various users via the activity feed.

According to an embodiment, the third party access manager 475 may provide versioning control in association with an accessed task list. Versioning control may be applied to an entire task list, or versioning control may be applied on an individual task list item basis. For example, if an accessing user makes a change to a task list item, other potential users, or the first/owning user may simultaneously access the task list, and without versioning control, such accessing users may not realize that a given task list item has been changed or is presently being changed. According to an embodiment, the third party access manager may monitor accessed task lists and task list items that are being accessed by any requesting user or by the first/owning user to ensure versioning control is maintained. If a task list item is presently being changed, and another requesting user requests access to the same task list item, the third party access manager may notify the requesting user that the requested task list item is presently checked out by another user, and that the requested task list item has been modified as of a certain date or time. In addition, modification information, including one or more authors of modifications, or the identifications of users who are presently modifying a given task list item may be provided. As should be appreciated, such versioning control information may be provided for an entire task list as opposed to individual task list items.

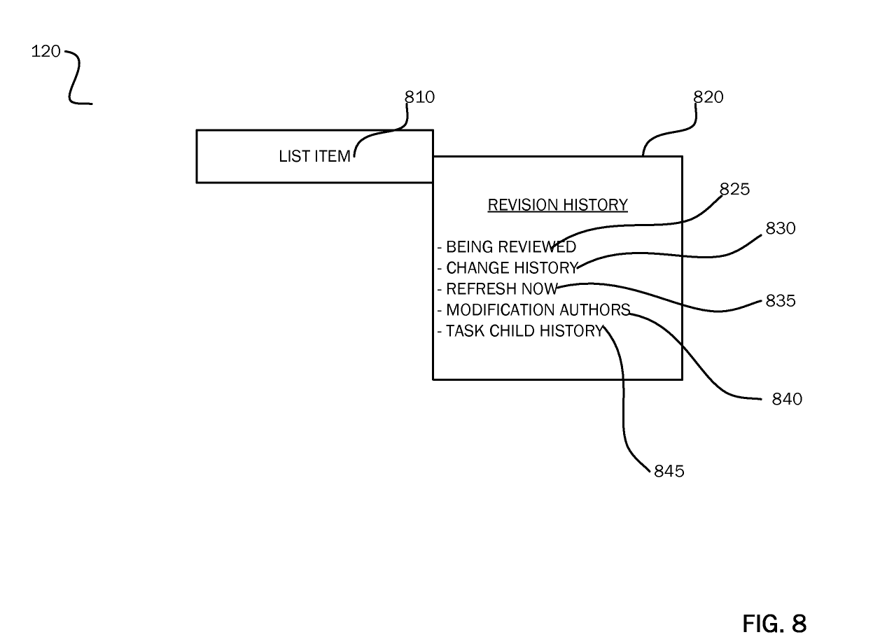

According to one embodiment, versioning control may be facilitated by annotating task list item information in the list 425 as given task list items are reviewed, modified, or saved. That is, as a given task list item is accessed, an annotation to the task list item in the list 425 may be made to indicate that the list item is presently being accessed and utilized by a requesting party. If changes are persisted to the list 425 for a given list item, then a variety of information including the time of the change, the author of the change, permissions available to the author of the change, and the like may be annotated to the task list item in the list 425 for subsequent reporting or utilization, as described below with reference to FIG. 8.

Referring now to FIG. 8, an example user interface component is illustrated for providing versioning control in association with task lists or individual task list items. The list authoring service user interface 120 is illustrated for displaying one or more task list items of a given task list. According to embodiments, if a requesting user selects a given task list item 810 a fly out interface 820, drop down interface 820, or pivot table may be provided by the third party access manager 475 for providing versioning control information in association with a given list item. For example, the revision history interface 820 may show that the list item is being reviewed by another user (825) along with a listing of who has access to this list. Change history (830) may show changes and information about changes made to the selected list item, or such changes may be automatically exposed to accessing users. In addition, a “Refresh now” control 835 may be provided to allow a requesting user to refresh the accessed list items so that any recent changes to the selected list item or other associated list items are refreshed in the user interface 120. According to one embodiment, a “refresh” of task list items may be done automatically without user action. Other information including modification authors (840) may be provided to allow a requesting user to learn the identities of those persons who have made changes to one or more list items 810. In addition, a control 845 may be provided to allow a requesting user to obtain information on changes made to tasks that are hierarchically-oriented below a selected task 810 as children or sub-tasks to the selected task 810. As should be appreciated, the information and controls illustrated in the menu or display 820 are for purposes of example only and are not limiting of other versioning information that may be provided. Also, the information illustrated in the menu or display 820 could be displayed in the UI 120 or in any other suitable user interface component.

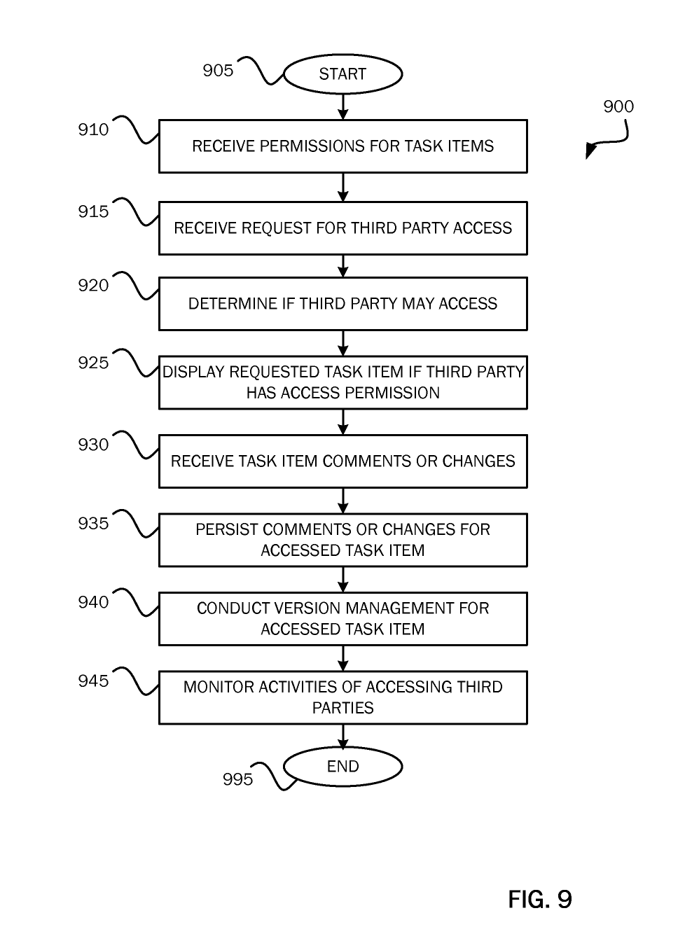

Having described features and operating environments of/for embodiments of the present invention, FIG. 9 is a flowchart illustrating a method for managing access to a user's task lists via social communications and media sites or other communication media. The method 900 begins at start operation 905 and proceeds to operation 910 where the third party access manager application 475 receives permissions from a first user/owner of a given task list to allow one or more other or requesting users to gain access to the one or more task lists. As described above, permissions may be prescribed in advance by the first user/owner, or permissions may be received from the first or owning user upon request after a third party has requested access to one or more task lists or task list items.

At operation 915, a request is received at the third party access manager application from one or more third parties to access one or more task lists or task list items. At operation 920, the third party access manager determines whether the requesting third party (parties) has (have) access permissions as granted by the owner of the requested task list or task list items. As described above, upon receiving a request for third party access, the first or owning user may grant access permissions on a case-by-case basis. The request for access may not be in the form of an active request by one party to receive one or more task list items. The request may be in the form of an automatic “push” of the task list items to a third party as prescribed by the first or owning user, and the determination of whether the third party has appropriate permissions for the task list items may be performed before the items are pushed to the third party.

At operation 925, if the requesting party has appropriate access permissions for the requested task lists or task list items, the requested task list or task list items may be displayed in a list authoring surface user interface 120, or other suitable display for displaying the requested content. At operation 930, one or more comments, changes, or other modifications to accessed task list items may be received from the accessing or requesting third party. As described above, the level of permissioned access will dictate the amount and types of changes or modifications the requesting or third party may make to accessed task lists or task list items. At operation 935, any changes, comments or other modifications made to one or more task list items are persisted to the list 425 via the server 420.

At operation 940, versioning control is maintained for the accessed task list items by the third party access manager application 475, as described above. At operation 945, various users of accessible task list items may monitor each other's activities with respect to the task list items to ensure accurate task list maintenance, and to ensure that each member of the accessing group is up-to-date on the status of various task list items. The method ends at operation 995.

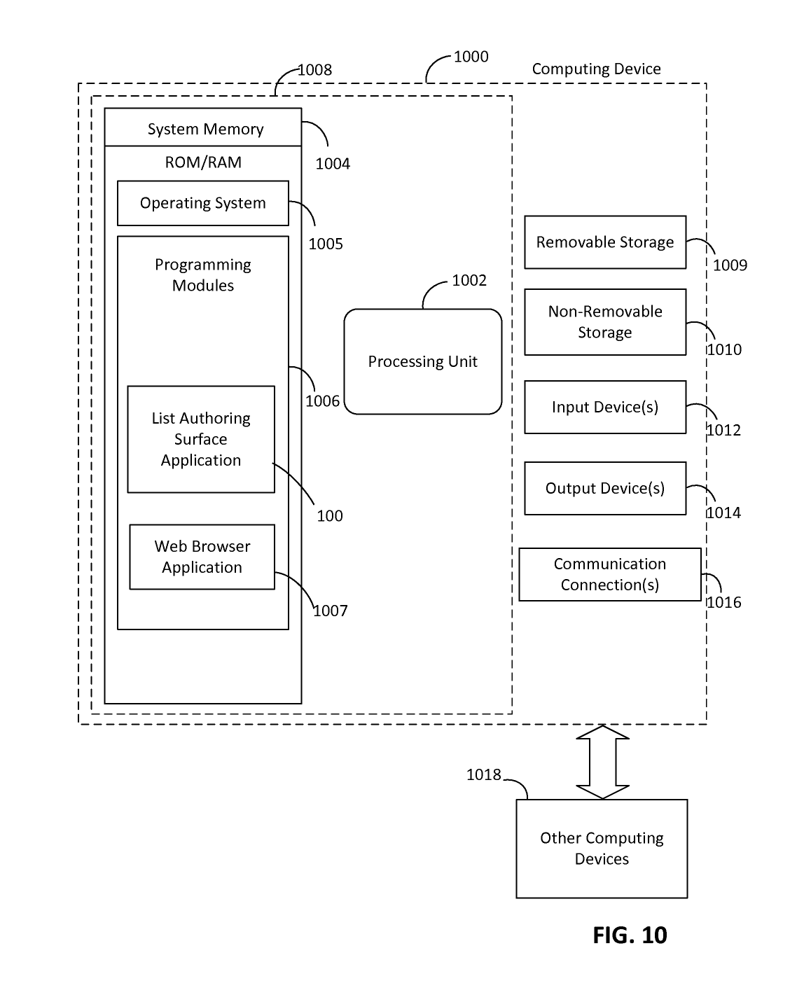

Having described embodiments of the present invention and an example logical flow illustrating a method for providing access to task lists via social communications systems, FIG. 10 is a block diagram illustrating example physical components of a computing device 1000 with which embodiments of the invention may be practiced. The computing device components described below may be suitable for the computing devices described above, for example, the computing devices 405, 410 and the server and database systems 420, 425. In a basic configuration, computing device 1000 may include at least one processing unit 1002 and a system memory 1004. Depending on the configuration and type of computing device, system memory 1004 may comprise, but is not limited to, volatile (e.g. random access memory (RAM)), non-volatile (e.g. read-only memory (ROM)), flash memory, or any combination. System memory 1004 may include operating system 1005, one or more programming modules 1006, and may include a web browser application 1020. Operating system 1005, for example, may be suitable for controlling computing device 1000's operation. In one embodiment, programming modules 1006 may include a logging engine 1020 embedded in a web page and/or installed on computing device 1000. Furthermore, embodiments of the invention may be practiced in conjunction with a graphics library, other operating systems, or any other application program and is not limited to any particular application or system. This basic configuration is illustrated in FIG. 10 by those components within a dashed line 1008.

Computing device 1000 may have additional features or functionality. For example, computing device 1000 may also include additional data storage devices (removable and/or non-removable) such as, for example, magnetic disks, optical disks, or tape. Such additional storage is illustrated in FIG. 10 by a removable storage 1009 and a non-removable storage 1010.

As stated above, a number of program modules and data files may be stored in system memory 1004, including operating system 1005. While executing on processing unit 1002, programming modules 1006, such as the list authoring surface application or module 100 described above with respect to FIG. 1 and the web browser application 1007 may perform processes including, for example, one or more method 1000's stages as described above. The aforementioned process is an example, and processing unit 1002 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. System memory 1004, removable storage 1009, and non-removable storage 1010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1000. Any such computer storage media may be part of device 1000. Computing device 1000 may also have input device(s) 1012 such as a keyboard, a mouse, a pen, a sound input device, a touch input device, etc. Output device(s) 1014 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

It will be apparent to those skilled in the art that various modifications or variations may be made in the present invention without departing from the scope or spirit of the invention. Other embodiments of the invention will be apparent to those skilled in the art from consideration of the specification and practice of the invention disclosed herein.

We claim:

1. A method for managing access to a user's task lists by third party access requesters, comprising:
receiving a task item;
receiving a request by the third party access requester for access to the task item;
determining if the third party access requester has a permission for access to the task item; and
if the third party access requester has a permission for access to the task item, displaying the task item to the third party access requester.

2. The method of claim 1, wherein displaying the task item to the third party access requester includes displaying to the third party access requester any changes to the task item.

3. The method of claim 1, wherein displaying the task item to the third party access requester includes displaying the task item to the third party access requester automatically without receiving an access request from the third party access requester if a permissioning type associated with the third party access requester requires automatic sharing of the task item with the requesting third party access requester.

4. The method of claim 1, wherein displaying the task item to the third party access requester includes displaying the task item to the third party access requester automatically without receiving an access request from the third party access requester if a permissioning type associated with the third party access requester requires automatic sharing of the task item with the requesting third party access requester based on a context associated with the task item.

5. The method of claim 1, wherein displaying the task item to the third party access requester includes displaying the task items to the third party access requester in a list authoring surface user interface regardless of an application or application content with which a generation of the task item was performed.

6. The method of claim 1, prior to receiving a request by the third party access requester for access to the task item, receiving a permission to allow access to the task item by a third party access requester.

7. The method of claim 6, further comprising receiving a permission to allow access to the task item by a third party access requester includes receiving a permission to allow the third party access requester to have read and write permissions for the task item.

8. The method of claim 6, further comprising receiving a permission to allow access to the task item by a third party access requester includes receiving a permission to allow the third party access requester to have read only permissions for the task item.

9. The method of claim 6, further comprising receiving a permission to allow access to the task item by a third party access requester includes receiving a permission to allow the third party access requester to have limited access to the task item, the limited access defined by a an owner of the task item.

10. The method of claim 1, after displaying the task item to the third party access requester, receiving a change to the displayed task item from the third party access requester, and automatically showing the change to the displayed task item to any party having access permissions to the task item, including an owner of the task item, that the task item has been changed.

11. The method of claim 10, wherein receiving a change to the displayed task item from the third party access requester includes persisting the change to the displayed task item to memory.

12. The method of claim 10, wherein receiving a change to the displayed task item from the third party access requester includes receiving a comment on the displayed task item from the third party access requester.

13. The method of claim 10, prior to receiving a change to the displayed task item from the third party access requester, assigning a version identification to the task item.

14. The method of claim 13, after receiving the change to the displayed task item, assigning a second version identification to the task item.

15. The method of claim 10, during receiving a change to the displayed task item from the third party access requester, if a second third party access requester requests access to the task item, notifying the second third party access requester that the task item is not a most recent version.

16. The method of claim 1, wherein receiving a request by the third party access requester for access to the task item includes receiving the request for access to the task item via a social communication.

17. The method of claim 16, further comprising monitoring access activities with respect to the task item of one or more third parties having access permissions for the task item, including an owner of the task item.

18. The method of claim 17, wherein monitoring access activities with respect to the task item of one or more third parties having access permissions for the task item, including an owner of the task item includes monitoring access activities with respect to the task item via an activities feed for the social communication that shows access activities with respect to the task item by any of the one or more third parties having access permissions for the task item, including the owner of the task item.

19. A computer readable medium containing computer-executable instructions which when executed by a computer perform a method for managing access to a user's task lists by third party access requesters, comprising:
receiving a task item;
receiving a permission to allow access to the task item by a third party access requester;
receiving a request by the third party access requester for access to the task item;
determining if the third party access requester has a permission for access to the task item;
if the third party access requester has a permission for access to the task item, displaying the task item to the third party access requester;
receiving a change to the displayed task item from the third party access requester;
during receiving a change to the displayed task item from the third party access requester, if a second third party access requester requests access to the task item, notifying the second third party access requester that the task item is not a most recent version; and
persisting the change to the displayed task item to memory.

20. A system for managing access to a user's task lists by third party access requesters, comprising:
a third party access manager application operative
to receive a task item from a list of task items organized via a list authoring surface;
to receive a request by the third party access requester for access to the task item;
to determine if the third party access requester has a permission for access to the task item;
to display the task item to the third party access requester if the third party access requester has a permission for access to the task item; and
if a second third party access requester requests access to the task item during receiving any changes to the displayed task item from the third party access requester, to notify the second third party access requester that the task item is not a most recent version.
